(19) United States
(12) Patent Application Publication
(10) Pub. No.: US 2011/0274590 A1
(43) Pub. Date: Nov. 10, 2011

(54) Inverted Exhaust Gas Treatment Injector

(76) Inventors: Ryan A. Floyd, Mason, MI (US); John Lowry, Brooklyn, MI (US)

(21) Appl. No.: 12/774,140

(22) Filed: May 5, 2010

(51) Int. Cl. B01D 53/94; B01D 50/00

(52) U.S. Cl. 422/177; 422/182

(57) ABSTRACT

An exhaust gas treatment system for reducing emissions from an engine includes an exhaust conduit adapted to supply an exhaust stream from the engine to an exhaust treatment device. The conduit includes an upstream zone, a reduced cross-sectional area zone, and a downstream zone. The upstream and downstream zones are positioned adjacent to and on either side of the reduced cross-sectional area zone. An injector is fixed to the exhaust conduit for injecting a reagent into the exhaust stream at the downstream zone, such that the reagent is injected into the exhaust stream at a venturi effect location of reduced exhaust pressure. The injector is mounted to spray reagent along an injection axis that extends at an angle ranging from 40 to 65 degrees from a longitudinal axis of the conduit.

### FIELD

The present disclosure relates to injector systems and, more particularly, relates to an injector system for injecting a reagent into an exhaust stream at a venturi effect location.

### BACKGROUND OF THE INVENTION

This section provides background information related to the present disclosure which is not necessarily prior art.

Lean burn engines provide improved fuel efficiency by operating with an excess of oxygen over the amount necessary for complete combustion of the fuel. Such engines are said to run “lean” or on a “lean mixture.” However, this increase in fuel economy is offset by undesired pollution emissions, specifically in the form of oxides of nitrogen (NOx).

One method used to reduce NOx emissions from lean burn internal combustion engines is known as selective catalytic reduction (SCR). SCR, when used, for example, to reduce NOx emissions from a diesel engine, involves injecting an atomized reagent into the exhaust stream of the engine in relation to one or more selected engine operational parameters, such as exhaust gas temperature, engine rpm or engine load as measured by engine fuel flow, turbo boost pressure or exhaust NOx mass flow. The reagent/exhaust gas mixture is passed through a reactor containing a catalyst, such as, for example, activated carbon, or metals, such as platinum, vanadium or tungsten, which are capable of reducing the NOx concentration in the presence of the reagent.

An aqueous urea solution is known to be an effective reagent in SCR systems for diesel engines. However, use of such an aqueous urea solution may include disadvantages. Urea is highly corrosive and attacks mechanical components of the SCR system, such as the injectors used to inject the urea mixture into the exhaust gas stream. Urea also tends to solidify upon prolonged exposure to high temperatures, such as encountered in diesel exhaust systems. Solidified urea may accumulate in the narrow passageways and exit orifice openings typically found in injectors. Solidified urea may foul moving parts of the injector and clog any openings, rendering the injector unusable. Solidified urea may also cause backpressure and emission reduction issues with a system. This concern exists because the reagent creates a deposit instead of reducing the NOx.

Several current injector systems include mounting arrangements that position the injector a predetermined distance away from the exhaust pipe. Some injector mounting arrangements may be referred to as a “dog house” or “stand-off” style. This mounting arrangement may introduce re-circulating vortices and cold spots at or near the injector mounting site and the urea exit orifice. During urea injection, the re-circulating vortices and reduced temperature in the mount area may lead to urea deposition that may clog the mount area and protrude into the exhaust gas stream.

In addition, if the urea mixture is not finely atomized, urea deposits may form in the catalytic reactor, inhibiting the action of the catalyst and thereby reducing the SCR system effectiveness. High injection pressures are one way of minimizing the problem of insufficient atomization of the urea mixture. However, high injection pressures often result in over-penetration of the injector spray plume into the exhaust stream, causing the plume to impinge on the inner surface of the exhaust pipe opposite the injector. Over-penetration leads to inefficient use of the urea mixture and reduces the range over which the vehicle can operate with reduced NOx emissions. Only a finite amount of aqueous urea can be carried on a vehicle, and what is carried should be used efficiently to maximize vehicle range and reduce the need for frequent fill ups of the reagent.

Further, aqueous urea is a poor lubricant. This characteristic adversely affects moving parts within the injector and requires that special fits, clearances and tolerances be employed between relatively moving parts within an injector. Aqueous urea also has a high propensity for leakage. This characteristic adversely affects mating surfaces requiring enhanced sealing resources in many locations.

It may be advantageous to provide methods and apparatus for injecting an aqueous urea solution into the exhaust stream of a lean burn engine to minimize urea deposition and to prolong the life of the injector components.

The methods and apparatus of the present disclosure provide the foregoing and other advantages.

### SUMMARY OF THE INVENTION

This section provides a general summary of the disclosure, and is not a comprehensive disclosure of its full scope or all of its features.

An exhaust gas treatment system for reducing emissions from an engine includes an exhaust conduit adapted to supply an exhaust stream from the engine to an exhaust treatment device. The conduit includes an upstream zone, a reduced cross-sectional area zone, and a downstream zone. The upstream and downstream zones are positioned adjacent to and on either side of the reduced cross-sectional area zone. An injector is fixed to the exhaust conduit for injecting a reagent into the exhaust stream at the downstream zone, such that the reagent is injected into the exhaust stream at a venturi effect location of reduced exhaust pressure. The injector is mounted to spray reagent along an injection axis that extends at an angle ranging from 40 to 65 degrees from a longitudinal axis of the conduit.

An exhaust gas treatment system for reducing emissions from an engine includes an exhaust conduit adapted to supply an exhaust stream from the engine to an exhaust treatment device. The conduit includes an indentation defining a reduced cross-sectional area zone. The indentation includes a mounting surface extending along a plane intersecting a longitudinal axis of the conduit at a first angle ranging from 25 to 50 degrees. An injector for injecting a reagent into the exhaust stream is positioned downstream of the reduced cross-sectional area zone and fixed to the mounting surface such that the reagent is injected into the exhaust stream at a zone of reduced exhaust pressure along an injection axis that extends transversely to the longitudinal axis at the first angle.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a schematic diagram of an exemplary diesel engine with a pollution emission control system using an injector arrangement according to the present teachings;

FIG. 2 is a perspective view of an inverted exhaust gas treatment assembly;

FIG. 3 is a cross-sectional view of the assembly shown in FIG. 2;

FIG. 4 is a top view of the exhaust gas treatment assembly;

FIG. 5 is a droplet trajectory model;

FIG. 6 is a side view of another exhaust gas treatment assembly including a two-piece tube assembly;

FIG. 7 is a perspective view depicting an alternate tube construction; and

FIG. 8 is a perspective view of an alternate exhaust gas treatment assembly including the tube of FIG. 7.

Corresponding reference numerals indicate corresponding parts throughout the several views of the drawings.

### DETAILED DESCRIPTION

Example embodiments will now be described more fully with reference to the accompanying drawings.

It should be understood that although the present teachings may be described in connection with diesel engines and the reduction of NOx emissions, the present teachings can be used in connection with any one of a number of exhaust streams, such as, by way of non-limiting example, those from diesel, gasoline, turbine, fuel cell, jet or any other power source outputting a discharge stream. Moreover, the present teachings may be used in connection with the reduction of any one of a number of undesired emissions. For example, injection of hydrocarbons for the regeneration of diesel particulate filters is also within the scope of the present disclosure. For additional description, attention should be directed to commonly-assigned U.S. Patent Application Publication No. 2009/0179087A1, filed Nov. 21, 2008, entitled “Method And Apparatus For Injecting Atomized Fluids”, which is incorporated herein by reference.

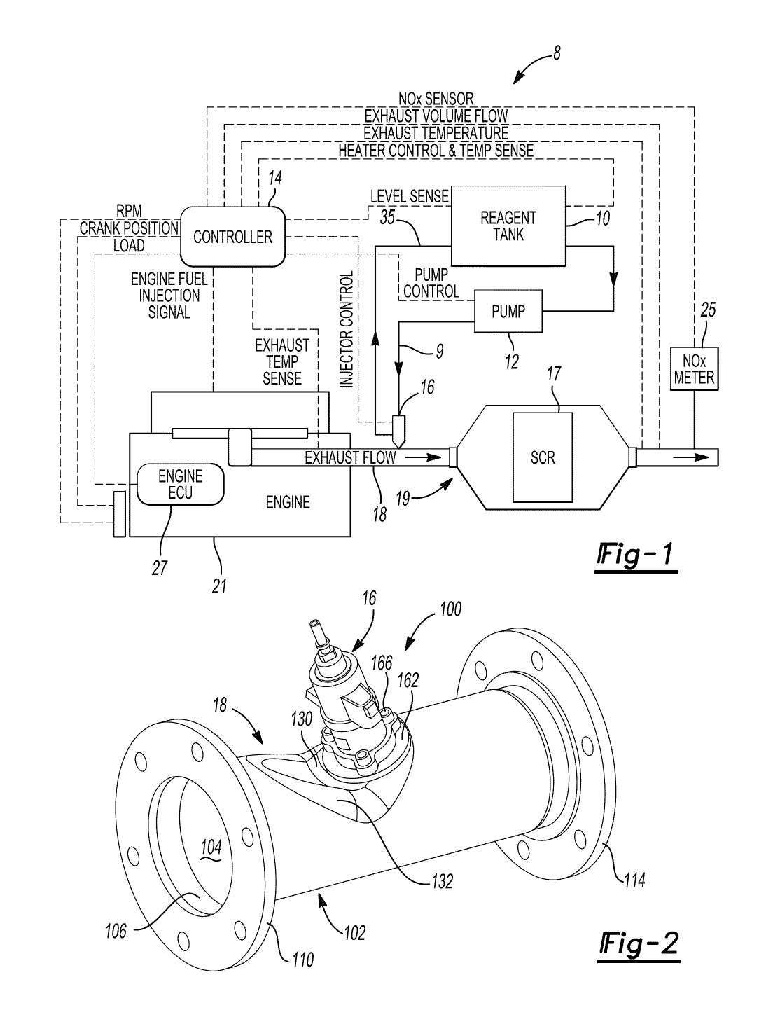

With reference to the Figures, a pollution control system 8 for reducing NOx emissions from the exhaust of a diesel engine 21 is provided. In FIG. 1, solid lines between the elements of the system denote fluid lines for reagent and dashed lines denote electrical connections. The system of the present teachings may include a reagent tank 10 for holding the reagent and a delivery module 12 for delivering the reagent from the tank 10. The reagent may be a urea solution, a hydrocarbon, an alkyl ester, alcohol, an organic compound, water, or the like and can be a blend or combination thereof. It should also be appreciated that one or more reagents can be available in the system and can be used singly or in combination. The tank 10 and delivery module 12 may form an integrated reagent tank/delivery module. Also provided as part of system 8 is an electronic injection controller 14, a reagent injector 16, and an exhaust system 19. Exhaust system 19 includes an exhaust conduit 18 providing an exhaust stream to at least one catalyst bed 17.

The delivery module 12 may comprise a pump that supplies reagent from the tank 10 via a supply line 9. The reagent tank 10 may be polypropylene, epoxy coated carbon steel, PVC, or stainless steel and sized according to the application (e.g., vehicle size, intended use of the vehicle, and the like). A pressure regulator (not shown) may be provided to maintain the system at predetermined pressure setpoint (e.g., relatively low pressures of approximately 60-80 psi, or in some embodiments a pressure of approximately 60-150 psi) and may be located in the return line 35 from the reagent injector 16. A pressure sensor may be provided in the supply line 9 leading to the reagent injector 16. The system may also incorporate various freeze protection strategies to thaw frozen urea or to prevent the urea from freezing. For example, during system operation, regardless of whether or not the injector is releasing reagent into the exhaust gases, reagent may be circulated continuously between the tank 10 and the reagent injector 16 to cool the injector and minimize the dwell time of the reagent in the injector so that the reagent remains cool. Continuous reagent circulation may be necessary for temperature-sensitive reagents, such as aqueous urea, which tend to solidify upon exposure to elevated temperatures of 300° C. to 650° C. as would be experienced in an engine exhaust system.

Furthermore, it may be desirable to keep the urea mixture within the injector below 140° C. and preferably in a lower operating range between 5° C. and 95° C. to ensure that solidification of the urea is prevented. Solidified urea, if allowed to form, may foul the moving parts and openings of the injector.

The amount of reagent required may vary with load, engine RPM, engine speed, exhaust gas temperature, exhaust gas flow, engine fuel injection timing, and desired NOx reduction. A NOx sensor or meter 25 is positioned downstream from catalyst bed 17. NOx sensor 25 is operable to output a signal indicative of the exhaust NOx content to engine control unit 27. All or some of the engine operating parameters may be supplied from the engine control unit 27 via the engine/vehicle databus to the reagent electronic injection controller 14. The reagent electronic injection controller 14 could also be included as part of the engine control unit 27. Exhaust gas temperature, exhaust gas flow and exhaust back pressure and other vehicle operating parameters may be measured by respective sensors.

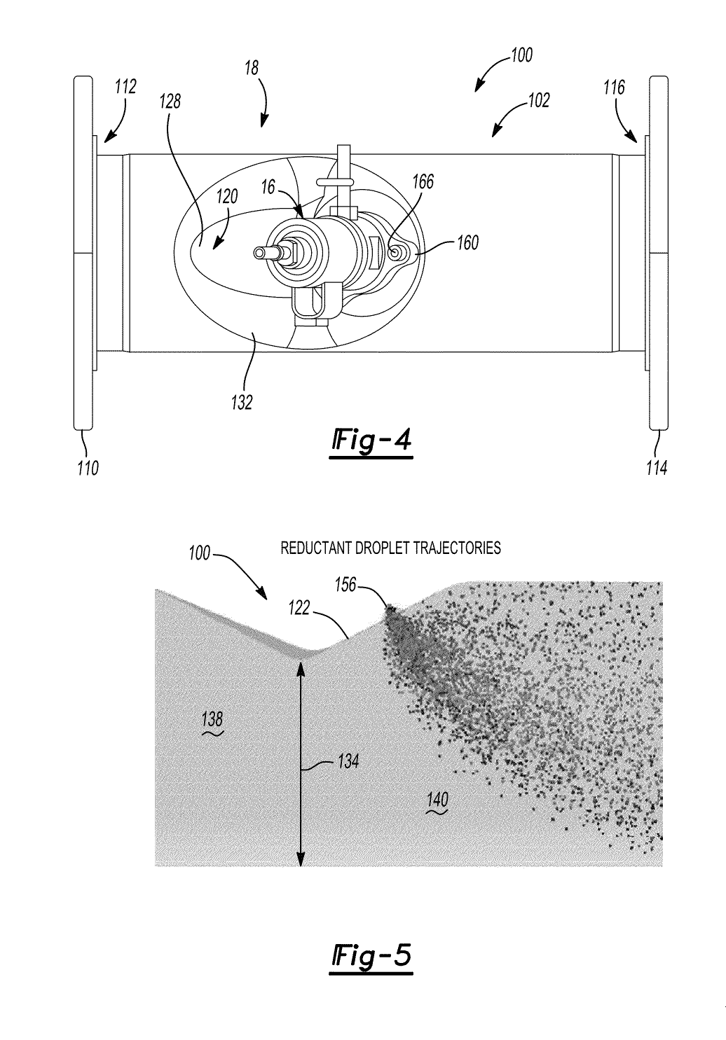

Referring now to FIGS. 2-4, an inverted exhaust gas treatment assembly 100 is defined to include exhaust conduit 18 and injector 16. Exhaust conduit 18 includes a substantially cylindrical tube 102 defining an exhaust passageway 104. Cylindrical tube 102 includes an inner surface 106 and an outer surface 108. A first flange 110 may be fixed to a first end 112 of cylindrical tube 102. In similar fashion, a second flange 114 may be fixed to a second end 116 of cylindrical tube 102.

A localized deformation or indentation 120 is formed along a portion of cylindrical tube 102. Indentation 120 radially inwardly protrudes into passageway 104 and includes an injector mounting surface 122 formed as a portion of outer surface 108. Mounting surface 122 is substantially planar and extends at an angle A relative to a longitudinal axis 124 of tube 102. It is contemplated that angle A may range from 25 to 50 degrees. Indentation 120 also includes a sloped surface 128 radially inwardly extending from cylindrical surface 108. A curved surface 130 interconnects mounting surface 122 and surface 128. Sloped surface 128 extends substantially at an angle B relative to the longitudinal axis of tube 102. Angle B is less than angle A. It should be appreciated that surfaces 128 and 130 may or may not include planar portions. To minimize stress concentrations, it is contemplated that a number of additional transition surfaces, one of which is identified at reference numeral 132, may be included to smoothly transition from the cylindrical shape of outer surface 108 to surfaces 128 and 122. Cylindrical tube 102 includes a substantially constant thickness wall such that inner surface 106 may include complex curved, as well as planar, portions corresponding to the shape and position of the outer surfaces defining indentation 120.

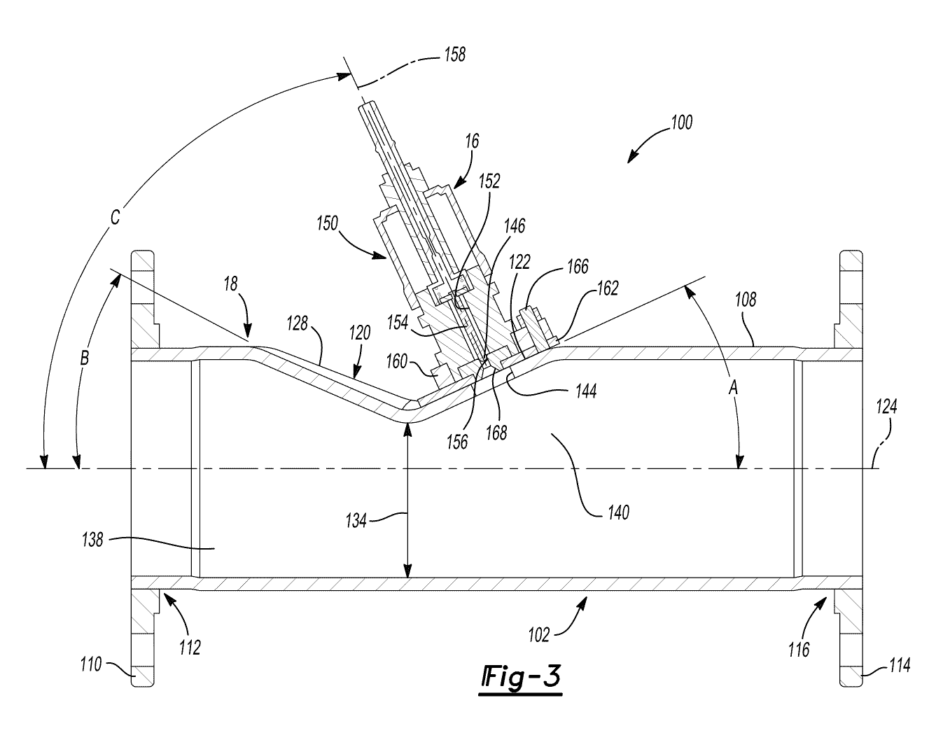

As best shown in FIG. 3, indentation 120 defines a minimal cross-sectional area at reference numeral 134. An upstream portion 138 of passageway 104 defines a greater cross-sectional than the area at numeral 134. In similar fashion, a downstream portion 140 of passageway 104 includes an enlarged cross-sectional area when compared to cross-sectional area 134. As such, a venturi effect is provided as exhaust gas passes from upstream portion 138 through reduced cross-sectional area portion 134 and into downstream portion 140. Due to the venturi effect, a low pressure zone is introduced near an aperture 144 extending through tube 102.

Injector 16 includes a body 150 defining a cylindrical chamber 152 in receipt of an axially translatable valve member 154. Body 150 includes an exit orifice 156 as a discharge location for injected urea. A valve seat 146 is formed proximate exit orifice 156 that is selectively engaged by valve member 154 to control urea injection into the exhaust gas flow path. Valve member 154 is translatable along an axis of reagent injection 158. Axis of injection 158 forms an angle C with the longitudinal axis of tube 102. Angle C is the complement of angle A and, as such, ranges from 40 to 65 degrees.

Body 150 includes a radially outwardly extending flange 160. A mounting plate 162 may be sandwiched between flange 160 and planar surface 122 to provide a more robust mounting structure. A plurality of fasteners 166 extend through flange 160 and mounting plate 162 to fix injector 16 to tube 102. Mounting plate 162 includes an aperture 168 extending therethrough to allow fluid communication between exit orifice 156 and passageway 104.

During operation of engine 21, combustion produces an exhaust flow through exhaust conduit 18. When electronic controller 14 determines that a reductant injection should occur, axially moveable valve member 154 is displaced to allow pressurized urea to spray from exit orifice 156 through aperture 168 and aperture 144 along injection axis 158 into the exhaust flow path at downstream portion 140.

FIG. 5 depicts a dispersion of reductant droplets during engine operation and reductant injection. Based on the downstream position of exit orifice 156 from reduced cross-sectional area portion 134, in combination with the direction of the injected spray, reductant droplets flow downstream and substantially uniformly disperse within portion 140. A recirculation flow of exhaust no longer exists due to the presence of a low pressure zone at or near exit orifice 156 based on the venturi effect. Based on this droplet distribution pattern, inner surface 106 of cylindrical tube 102 is not coated with liquid urea at or near aperture 144. Accordingly, solidified deposits of urea are not formed at or near exit orifice 156. Reductant continues to flow downstream unimpeded to impact SCR 17. To form a reduced pressure zone at or near aperture 144 and minimize re-circulation, tube 102 is substantially unobstructed downstream of reduced cross-sectional area 134.

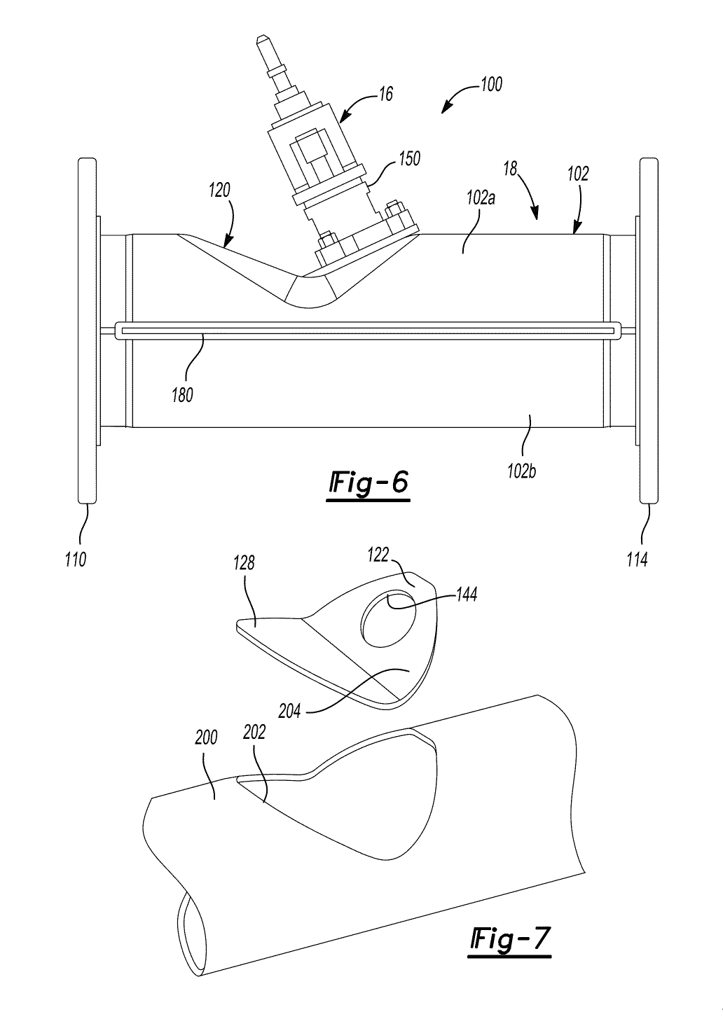

It is contemplated that exhaust conduit 18 may be manufactured in a number of different ways. In a first exemplary manufacturing process, a hollow cylindrical tube 102 without indentation 120 is formed. Indentation 120 may be defined through the use of a number of manufacturing processes including hydroforming, stamping or swaging. Internal mandrels may or may not be necessary to properly define the shape of indentation 120. In an alternative manufacturing process, tubular portion 102 may be constructed from two separate halves using a clam shell approach, as shown in FIG. 6. A first shell 102a of the tube including indentation 120 is formed in a stamping operation to define approximately one-half of the tube 102. A second opposing shell 102b may be defined in a sheet metal rolling or stamping process. The second shell 102b does not include indentation 120. After forming the desired clam shell shapes, the halves are coupled to one another via a suitable process such as welding. A weld 180 longitudinally extends on both sides of the tube depicted in FIG. 6.

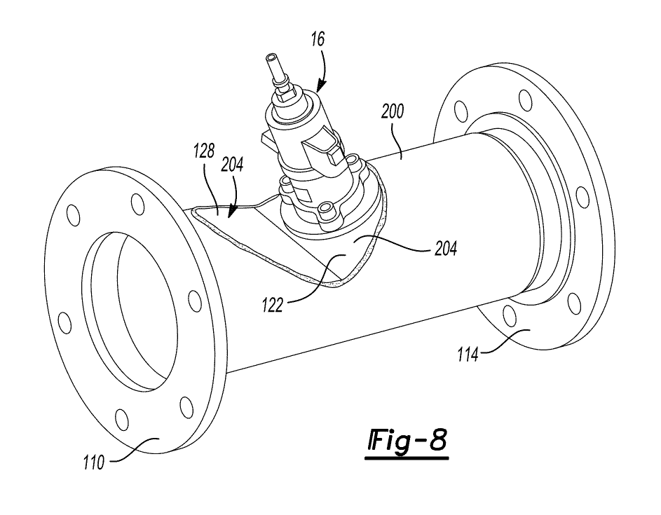

In yet another method of manufacture, a substantially cylindrical tube 200 may be cut or otherwise machined to define an elongated aperture 202, as shown in FIG. 7. A plate 204 may be constructed from a substantially planar sheet of metal to include a single bend thereby defining surfaces 128 and 122. Aperture 144 may also be defined during a stamping operation used to manufacture plate 204. Plate 204 is subsequently positioned within aperture 202 and welded to tube 200 as depicted in FIG. 8. Flanges 110 and 114 may also be welded to tube 200.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An exhaust gas treatment system for reducing emissions from an engine, the system comprising:
an exhaust treatment device;
an exhaust conduit adapted to supply an exhaust stream from the engine to the exhaust treatment device, the conduit including an indentation defining a reduced cross-sectional area zone, the indentation including a mounting surface extending along a plane intersecting a longitudinal axis of the conduit at a first angle ranging from 25 to 50 degrees; and
an injector for injecting a reagent into the exhaust stream, being positioned downstream of the reduced cross-sectional area zone and fixed to the mounting surface such that the reagent is injected into the exhaust stream at a zone of reduced exhaust pressure along an injection axis that extends transversely to the longitudinal axis at the first angle.

2. The exhaust gas treatment system of claim 1 wherein the indentation circumferentially extends less than 180 degrees.

3. The exhaust gas treatment system of claim 1 wherein the indentation includes a substantially planar sloped surface radially inwardly extending from an outer cylindrical surface of the conduit to intersect the mounting surface.

4. The exhaust gas treatment system of claim 3 wherein the sloped surface intersects the longitudinal axis at a second angle less than the first angle.

5. The exhaust gas treatment system of claim 1 wherein the conduit includes a first shell including the indentation fixed to a second shell, the first and second shells being connected at a longitudinally extending seam.

6. The exhaust gas treatment system of claim 1 wherein the conduit is shaped downstream of the reduced cross-sectional area zone to allow the reductant to flow downstream without recirculation.

7. The exhaust gas treatment system of claim 1 wherein the conduit includes a substantially constant wall thickness.

8. The exhaust gas treatment system of claim 1 wherein the conduit includes a tube including an elongated opening in the side wall of the tube and an angled plate fixed to the tube to sealingly cover the opening.

9. The exhaust gas treatment system of claim 8 wherein the injector is fixed to the plate.

10. An exhaust gas treatment system for reducing emissions from an engine, the system comprising:
an exhaust treatment device;
an exhaust conduit adapted to supply an exhaust stream from the engine to the exhaust treatment device, the conduit including an upstream zone, a reduced cross-sectional area zone, and a downstream zone, the upstream and downstream zones being positioned adjacent to and on either side of the reduced cross-sectional area zone; and
an injector fixed to the exhaust conduit for injecting a reagent into the exhaust stream at the downstream zone such that the reagent is injected into the exhaust stream at a venturi effect location of reduced exhaust pressure, the injector being mounted to spray reagent along an injection axis that extends at an angle ranging from 40 to 65 degrees from a longitudinal axis of the conduit.

11. The exhaust gas treatment system of claim 10 wherein the downstream zone is substantially free from obstructions to exhaust flow.

12. The exhaust gas treatment system of claim 10 wherein the injected reagent continues to flow downstream within the exhaust after injection until reaching the exhaust treatment device.

13. The exhaust gas treatment system of claim 12 wherein the exhaust treatment device includes a catalyst.

14. The exhaust gas treatment system of claim 10 wherein the conduit includes a radially inwardly extending protrusion defining the reduced cross-sectional area zone.

15. The exhaust gas treatment system of claim 14 wherein the protrusion is monolithic to the conduit.

16. The exhaust gas treatment system of claim 15 wherein the injector is fixed to the protrusion.

17. The exhaust gas treatment system of claim 16 wherein a portion of the protrusion extends along a plane intersecting the longitudinal axis at a complement of the angle.

18. The exhaust gas treatment system of claim 14 wherein the protrusion includes a radially inwardly extending sloped surface being contiguous with an outer cylindrical surface of the conduit.
